(19) United States
(12) Patent Application Publication
(10) Pub. No.: US 2013/0173342 A1
(43) Pub. Date: Jul. 4, 2013

(54) SYSTEM AND METHOD FOR VALUATION OF A TECHNOLOGY

(71) Applicant: Innospan Enterprises, Inc., Draper, UT (US)

(72) Inventor: Matt Bills, Draper, UT (US)

(73) Assignee: INNOSPAN ENTERPRISES, INC., Draper, UT (US)

(21) Appl. No.: 13/671,161

(22) Filed: Nov. 7, 2012

Related U.S. Application Data
(60) Provisional application No. 61/556,825, filed on Nov. 8, 2011.

(51) Int. Cl. G06Q 30/02

(52) U.S. Cl. CPC G06Q 30/0202
USPC 705/7.31

(57) ABSTRACT

A system and method for computing the value of an emerging technology is provided. The method may provide an automated process to provide objective data for valuation of a given technology. The method may use a multi-variant algorithm that has weighted measures, such as multiple parameters having one or more subsegments. Each parameter may be assigned a variable relative to its importance to the success of the ultimate success of the technology and each subsegment within a parameter may be given a different value. Information regarding a particular technology may be entered and an overall value of a technology determined.

### THE FIELD OF THE INVENTION

The present invention relates to valuation methodologies. More specifically, the present invention relates to a system and method of determining the value of technology. The system and method should be able to provide an objective valuation of the technology at various stages of development, from conception through full development.

### BACKGROUND

It has been estimated that up to three quarters of the value of US public companies is now based on their intangible assets (up from 40% in 1980). See generally, A Market for Ideas, The Economist, Oct. 22, 2005, at 3, 3 (special insert). Often, as much as 100% of a small startup company's value may be based on its intellectual property. However, such companies usually have no idea how to value their inventions. Similarly, individual inventors are often unable to correctly value their inventions. This is unfortunate as the inability to value intangible assets puts companies, and individual inventors, at a severe disadvantage when trying to monetize their discoveries, such as through licensing, joint-ventures, sales, capital raises, etc.

Inventors may spend many years creating promising technologies. Such technologies may be of great value; however, assigning a value to a technology may be very complex. The difficulty in valuation of a particular technology is often due to the uncertainties about both the technical and commercial successes of the underlying technology in competitive markets. For example, the valuation process may involve determining the present value of a technology against the value of a future product when the product is still at the stage of conception. Without being able to articulate the value of their technology at such an early stage, an inventor is unlikely to receive the proper value for his or her invention.

Companies with an emerging technology face similar challenges. Typically traditional business valuations are based on income, assets, cost approach and historical performance. However, significant valuation challenges are presented when the value of a company with an emerging technology must be determined, because they typically have limited revenues, few fixed assets, and a history of losses.

Furthermore, a particular technology may represent the first of its kind. Therefore, it may be difficult to find a peer group or competitors to use as a benchmark for performance for that technology. So, investors in such technology often must gamble hoping that the future of the technology will provide large returns.

Potential licensees that are attracted to, or have a compelling need to, acquire or license emerging technologies are often faced with a similar dilemma. These licensees must place a value on the technology and negotiate an agreement that will provide an attractive return. However, due to the complexity of valuing an emerging technology at varying stages of its development, determining the proper value of the technology is difficult. Furthermore, disagreement as to the value of the technology between a potential licensee and an inventor may hinder license negotiations.

Thus there is a need for an improved system and method of determining the value of technology as it progresses through development. The system and method may provide for automated, objective valuation of technology for various fields.

### SUMMARY OF THE INVENTION

It is an object of the present invention to provide an improved system for determining the value of an emerging technology.

According to one aspect of the invention, a method for computing the value of an emerging technology is provided. The method may provide an automated process to provide objective data for valuation of a given technology.

According to another aspect of the invention, the method may use a multi-variant algorithm that has weighted measures.

According to another aspect of the invention, the method may include selecting parameters which may be indicators for success of a technology within a particular field.

According to another aspect of the present invention, a method for computing the value of an emerging technology may include parameters having one or more subsegments.

According to another aspect of the invention, a method for computing the value of an emerging technology may include assigning a variable to each parameter and different values to each subsegment within a given parameter.

According to another aspect of the invention, the variable assigned to each parameter and the values of the subsegments may be adjustable.

According to still another aspect of the invention, a method for computing the value of an emerging technology may include determining ranges for evaluating the overall value of an emerging technology.

According to yet another aspect of the invention, a method for computing the value of an emerging technology may include entering information regarding the development, difficulties, potentials, etc., of a given technology by selecting the subsegment in each parameter that best describes the invention. After a subsegment for each parameter has been selected, the value of that subsegment may be multiplied by the variable assigned to the parameter to obtain a product for that parameter. The products for each parameter may be added together to obtain a total value of the technology which may be compared to the valuation ranges.

According to another aspect of the invention, a method for computing the value of medical device technology is provided.

According to another aspect of the invention, computer software executing the modes of the invention is used to give a valuation determination on an inventive concept.

These and other aspects of the present invention are realized in a system and method of determining the value of technology as it progresses through development as shown and described in the following figures and related description.

### BRIEF DESCRIPTION OF THE DRAWINGS

Various embodiments of the present invention are shown and described in reference to the numbered drawings wherein:

FIG. 1 shows an apparatus in accordance with the present invention, in simplified block diagram;

FIG. 2 shows a flowchart for of a method for determining the value of a technology according to principles of the present invention;

FIGS. 3A and 3B show a spreadsheet of parameters having one or more subsegments which may be used to determine the value of medical device technology; and

FIGS. 4A and 4B show exemplary valuations of medical devices using the parameters described in FIGS. 3A and 3B.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

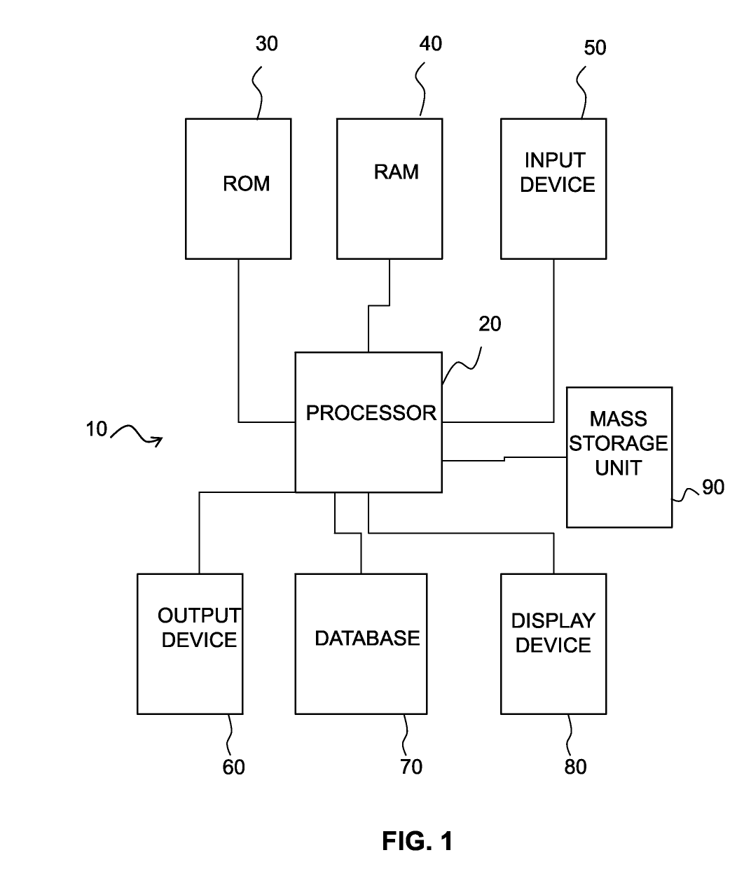

Turning now to FIG. 1, a simplified block diagram representation of a valuation system 10 in accordance with the present invention is shown. The figure does not necessarily show all of the system's hardware and software modules, and omits many physical and logical connections which will be apparent to one of ordinary skill in the art after review of the present disclosure. The system 10 can be implemented with a special purpose data processor, a general-purpose computer, a computer system, or a group of networked computers or computer systems configured to perform the steps or modes of the methods of the invention, to generate and process technology valuation information and to assign value estimates. According to one aspect, the system 10 may built on a personal computer platform, such as a PC or a Mac computer. According to another aspect, the system 10 may be a computer network within a client/server environment. According to yet another aspect, the system 10 may be implemented on the Internet, an intranet or an extranet.

The system 10 may execute instructions causing it to perform the steps of the methods described below, receiving the inputs and producing the results as indicated. The instructions may take the form of program code embodied in tangible media, such as hard drives, floppy diskettes, CD-ROMS, DVD, or any other machine-readable storage medium. The program code can also be transmitted over a transmission medium, for example, over electrical wiring or cabling, through fiber optics, through the Internet, wirelessly, or via any other form of transmission.

With reference to FIG. 1, the system 10 may include a processor 20 that can perform the processing routines and control functions of the methods in accordance with the invention. The system 10 may also include memory arrays 30 and 40, and a mass storage device 90. In the illustrated embodiment, the memory array 30 is a read only memory (ROM) device, the memory array 40 is a random access memory (RAM) device, and the mass storage device 90 is a magnetic disk drive, or a conventional hard drive. The mass storage device 90 and each of the memory arrays 30 and 40 may be connected to the processor 20.

A user input device 50 is used to enter data or commands into the system 10. The input device 50 can include, for example, the following mechanisms: a keyboard; a scanner; a user pointing device such as, for example, a mouse, a trackball, or a touch pad. As illustrated in FIG. 1, the user input device 50 may connected to the processor 20. The user input device 50 may be connected to the processor 20, for example, directly or through a local area network (LAN), through a wide area network (WAN) through a wired or wireless network, through the Internet, an intranet or an extranet.

The system 10 may also include a database 70 for storing the data that may be needed or desired in performing the method steps described herein. The database 70 can be a physically separate system coupled to the processor 20, as illustrated. In one version of the system 10, the processor 20 and the mass storage device 90 perform the functions of the database 70.

The system 10 can further include one or more output devices, for example, a display 50 and a printer 80. The output devices provide information, such as computational results, to the user. The one or more output devices may be located in a different location than the processor 20 and may be connected to the processor 20, for example, directly or through a local area network (LAN), through a wide are network (WAN) through a wired or wireless network, through the Internet, an intranet or an extranet.

According to one aspect of the invention, the system 10 may perform mathematical steps of the inventive process that provides for an objective valuation of an emerging technology. The inventive process may be used for valuation of different emerging technologies, each of which may be at different stages of development. Alternatively, the inventive process may be used for valuation of a particular emerging technology at different time points as the particular emerging technology progresses through various stages of development. As used herein, the definition of “emerging technology” includes any technical innovation which represents progressive or disruptive developments within a field.

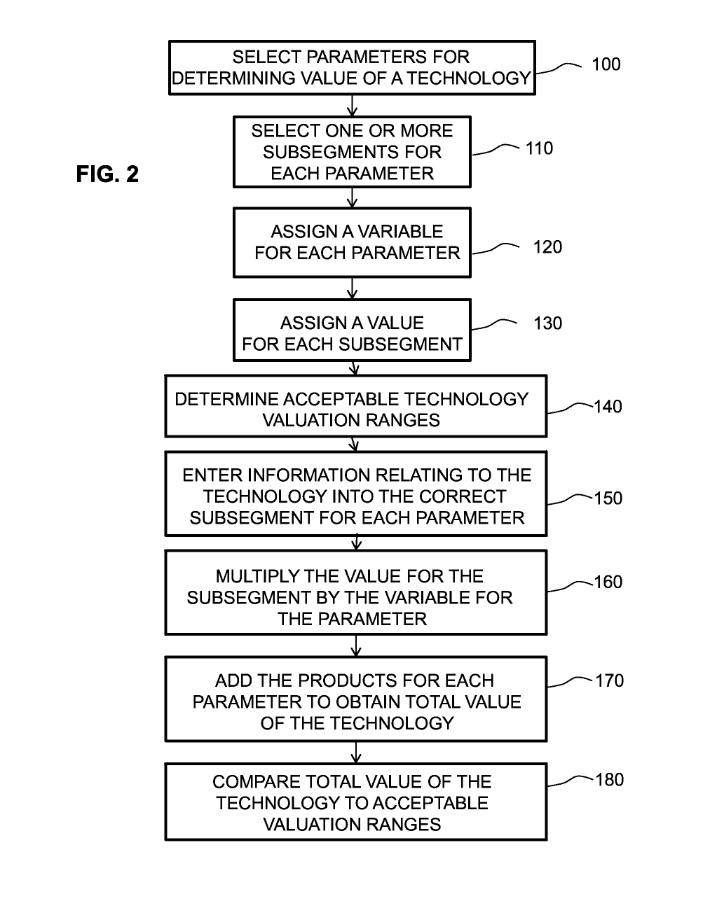

Turning now to FIG. 2, there is shown a flowchart for of a method for determining the value of a technology according to principles of the present invention. The method may provide an automated process for valuation of a given technology. The automated process may provide objective data about the technology. The method may use a multi-variant algorithm with weighted measures to produce the objective data. This objective data may be beneficial, for example, during license negotiations such as between an inventor and potential licensee. The objective data may help aid in the decision of whether such technology is valuable to license and, if so, facilitate negotiations of the license.

The first step 100 in the method is to select parameters, segments, quotients, or the like, that may be traditional indicators of success for technology in a given field. One or more subsegments may be selected for each parameter, as is shown in step 110. A variable may be assigned to each parameter 120. The variable for one parameter may differ as compared to another parameter in the method. For example, a first parameter may be viewed as more important to the success of the technology than a second parameter, thus, the first parameter may have a variable with a greater value. The variable for a given parameter may be adjusted by the user depending on the importance given to that parameter.

Next, a value may be assigned 130 to the one or more subsegments in each parameter. For example, a different value may be assigned to each subsegment for a given parameter. The subsegments may indicate the stage of development a technology has reached within a given parameter, a level of difficulty that may be encountered in the development of the technology, etc., and the value assigned to a particular subsegment may be reflective of these factors. The values assigned to each subsegment may increase according to a Fibonacci sequence. Alternatively, values may be assigned according to the user's preference. It will be appreciated that values may be assigned to each parameter using a variety of methods.

Once, the variables have been assigned to each parameter and the values have been assigned to each subsegment, an acceptable valuation range for the technology may be determined 140. The ranges may be determined by the user of the method. For example, a potential licensee who is only interested in very high value technology may shift the range upward to bias against most technology. Whereas, a potential licensee who is interested in obtaining licenses with respect to a large number of similar technologies may lower the threshold of the ranges to ensure that a larger representative of similar technologies are included.

Information regarding the technology may then be entered 150. For each parameter, the subsegment that best describes the development of the technology should be selected. After a subsegment for each parameter has been selected, the value of that segment may be multiplied by the variable assigned to the parameter to obtain a product for that parameter 160. The products for each parameter may added together to obtain a total value of the technology 170. The total value of the technology may then be compared to the determined valuation ranges 180.

The method may provide benefits for both inventors of new technology and those looking to capitalize on the value of that technology. For example, an inventor may be provided with objective data to better articulate the value of his or her technology, even if the technology is at an early stage of development Likewise, a potential licensee, for example, is able to better understand the value of a particular technology even if there are substantial risks in its development. Such information may facilitate the ability of new technologies to be obtained by an appropriate party to ensure the greatest likelihood that the technology ultimately makes it to market.

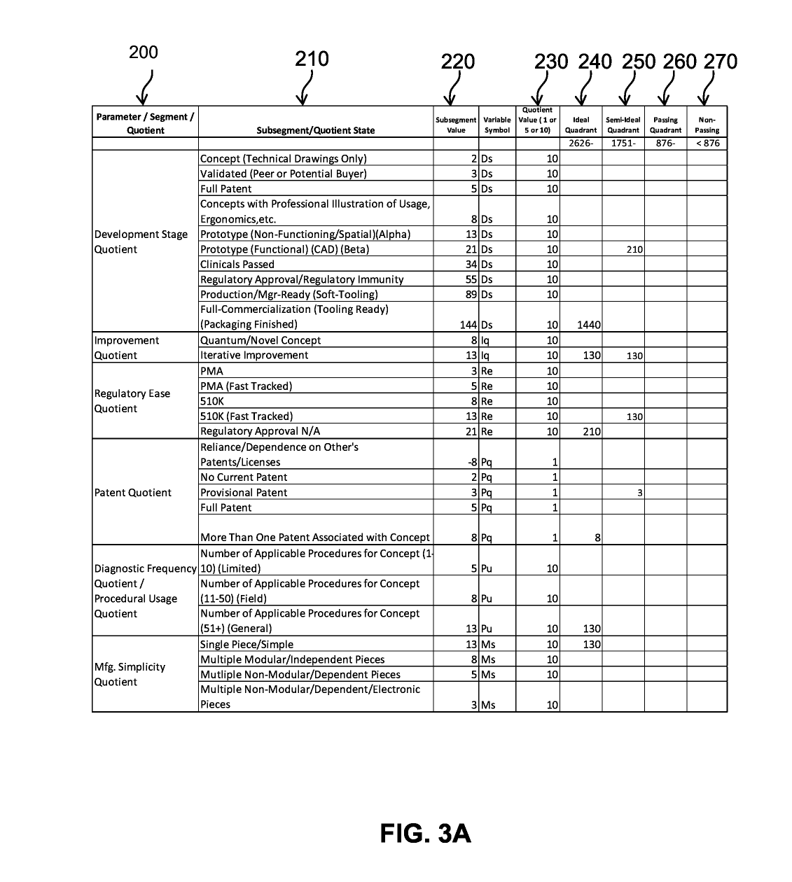

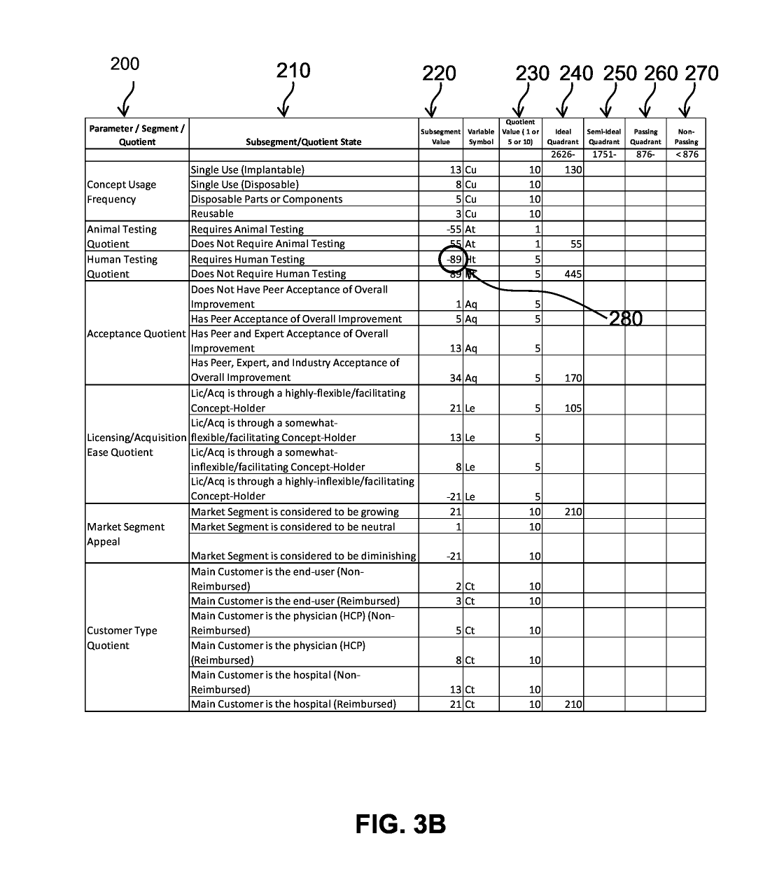

Turning now to FIGS. 3A and 3B, there is shown a spreadsheet of parameters having one or more subsegments which may be used to determine the value of medical device technology. In the particular example shown in FIGS. 3A and 3B, fifteen parameters, generally indicated at 200, may be selected. (It will be appreciated, however, that more or less parameters may be selected). Each individual parameter 200 may describe information that has traditionally been linked to success of medical devices in the market place in general. Each parameter 200 may include one or more subsegments, generally indicated at 210. Each subsegment 210 may further refine the parameter in which it is associated. For example, the size of the market for a given product may be known to contribute to the success of that product. Thus, the subsegments may refine the market segment appeal parameter as follows: (1) market segment is considered to be growing; (2) market segment is considered to be neutral; (3) market segment is considered to be diminishing.

Furthermore, it may be generally accepted that products that will be entering a growing market may generally enjoy more success, whereas products that will be entering a market that is diminishing in size will tend to have less success. Thus, differing values 220 may be assigned to the different subsegments within a given parameter to aid in the determination of the value of a new medical device. In some instances, the values given to the subsegments within a particular parameter may increase according to a Fibonacci sequence, as is shown in relation to the Development Stage Quotient. In other instances, the values may vary depending on the importance a particular user views the contribution a subsegment provides to the overall value of the medical device. For example, the requirement for human testing may be a substantial obstacle for a medical device to overcome, thus large differing values may be assigned based on whether human testing will be necessary.

Additionally, each parameter may be assigned a variable 230 depending on the relative importance that each individual parameter is viewed as important to the value of the invention. Again as an example, animal testing may be seen as a fairly routine and not too onerous of a task to overcome with most medical devices and thus be attributed a lower variable as compared to if human testing is required, which often involves more difficulties and expense.

Once the parameters and subsegments for each parameter are determined, information relating to a technology may be entered by selecting the subsegment that best describes the technology within a given parameter. The value 220 of the chosen subsegment may then be multiplied by the variable 230 for each parameter. An overall total value number for the technology can be obtained by adding the products from each parameter together.

According to one aspect of the invention, valuation ranges 240, 250, 260, 270 may be determined for comparison to the overall total value number for the technology. The valuation ranges may provide aid in the determination of whether the value of a given medical device is sufficiently high to indicate that it will be successful in the market place. The value ranges may be separated into more than one quadrant. For example, the ideal quadrant 240 may indicate a very high likelihood that the medical device will be successful. The semi-ideal quadrant 250 may indicate that the medical device is likely to be successful. The passing quadrant 260 may indicate that the medical device has a reasonable likelihood of being successful. And, the non-passing quadrant 270 may indicate that the medical device is likely to be unsuccessful in the market place given its current stage of development.

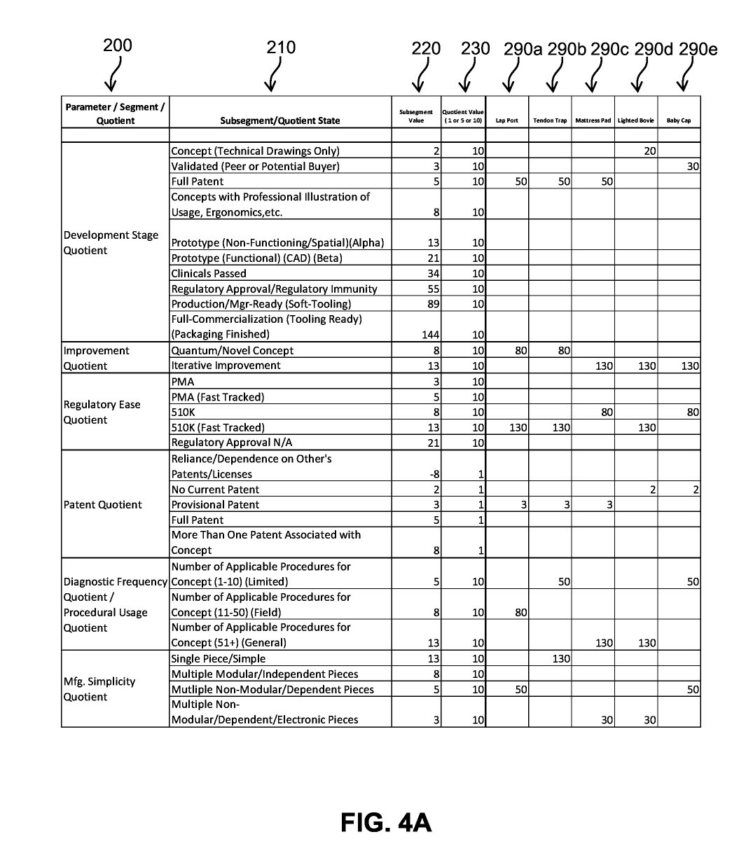

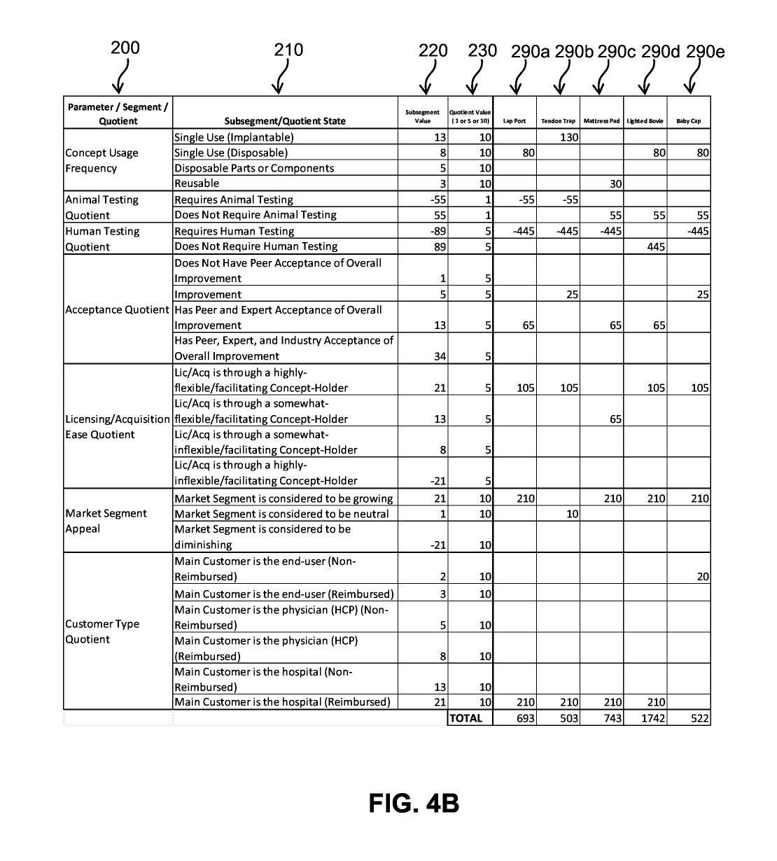

Turning now to FIGS. 4A and 4B, there are shown exemplary valuations of medical devices using the parameters describe above. The total value numbers for various technologies 290a-e in early stage development are determined using the method of the present invention. As is shown, the total value number for the lighted bovie 290d may indicate that this medical device may have a reasonable likelihood of success in the market place. Such information may be helpful for an inventor who is looking to license his technology to a potential licensee. The inventor is able to provide objective data to the potential licensee which in turn may facilitate negotiations that will lead to an agreement to increase the likelihood that the product will make it to market.

As for technologies which have returned a total value number in the non-passing quadrant, this may aid the inventor in determining whether to further pursue the device. Alternatively, it may show that the device should be further developed prior to introducing it to parties that may be later interested in investing in the technology. Once these products have been further developed, the method may be used again to determine the value of the technology. Thus, both time and expense may be saved by those utilizing the present invention.

Once the innovation is provided with a score, it can be classified in the ideal, semi-ideal, passing or non-passing quadrant and a determination made if the innovation is worth pursuing and at what price.

There is thus disclosed an improved system and method of determining the value of technology as it progresses through development. It will be appreciated that numerous changes may be made to the present invention without departing from the scope of the claims.

What is claimed is:

1. A system for determining the value of a technology comprising:
a processor configured for receiving information relative to a first parameter associated with a technology;
an input device for providing the processor with information about the technology;
wherein the first parameter is configured to provide indicia of the success of the technology in the market place; and
wherein the processor uses the information provided from the input device to generate a valuation of the technology.

2. The system according to claim 1, wherein the first parameter further comprises a plurality of first subsegments.

3. The system according to claim 2, wherein the first parameter is assigned a first variable and each of the plurality of first subsegments are assigned a different value to thereby provide for a valuation of the technology which is the result of a weighted measure.

4. The system according to claim 1, wherein the system further comprises valuation ranges for the technology.

5. The system according to claim 1, further comprising a plurality of parameters configured to provide indicia of the success of the technology in the market place.

6. The system according to claim 5, wherein each of the plurality of parameters comprises a plurality of subsegments each having a different value.

7. The system according to claim 6, wherein the first parameter is assigned a first variable and a second parameter of the plurality of parameter is assigned a second variable different from the first variable.

8. The system according to claim 7, wherein the processor multiplies the first variable by a chosen subsegment from the plurality of first subsegments and the process multiplies the second variable by a chosen subsegment form a plurality of second subsegments associated with the second parameter, and wherein the process adds the products together to thereby provide for a valuation of the technology which is the result of a weighted measure.

9. The system according to claim 3, wherein the input device allows a user to manual change at least one of the variables assigned to the first parameter or a value assigned to a subsegment from the plurality of first subsegments.

10. The system according to claim 3, wherein the different values assigned to each subsegment of the plurality of first subsegments increase according to a Fibonacci sequence.

11. A computer-implemented method for determining the value of a technology comprising the steps of:
selecting a plurality of parameters, each parameter having one or more subsegments;
assigning differing values for the one or more subsegments associated with each parameter;
selecting a technology and choosing a subsegment of the one or more subsegments that best describes the technology for each parameter;
adding the values of the one or more subsegments chosen for each parameter to obtain a value for the technology;
wherein the plurality of parameters and the one or more subsegments are configured to provide objective information about the success of the technology in the market place.

12. The method according to claim 11, further comprising the step of assigning a variable to each of the plurality of parameters, wherein the plurality of parameters comprise a first parameter having a first variable assigned thereto and a second parameter having a second variable assigned thereto, and wherein the first variable is different than the second variable.

13. The method according to claim 12, wherein the value of the one or more subsegments associated with the first parameter is multiplied by the first variable prior to the step of adding the values of the chosen one or more subsegments, and the value of the one or more subsegments associated with the second parameter is multiplied by the second variable prior to the step of adding the values of the chosen one or more subsegments.

14. The method according to claim 11, further comprising the step of determining valuation ranges for the technology for comparison with the objective data obtained from adding the values of the one or more subsegments chosen for each parameter.

15. The method according to claim 11, wherein the technology is a medical device.
